(19) United States
(12) Patent Application Publication
(10) Pub. No.: US 2015/0131402 A1
(43) Pub. Date: May 14, 2015

(54) APPARATUS AND METHOD FOR MIXING AND COOLING A BEVERAGE

(71) Applicant: Zachary L. Stinson, Lynchburg, VA (US)

(72) Inventor: Zachary L. Stinson, Lynchburg, VA (US)

(21) Appl. No.: 14/078,618

(22) Filed: Nov. 13, 2013

(51) Int. Cl. A47J 43/27

(52) U.S. Cl. CPC A47J 43/27
USPC 366/130

(57) ABSTRACT

A beverage shaker for mixing ingredients, cooling the beverage, and, shaving ice and simultaneously producing shavings of flavoring ingredients and/or ice to enhance the flavor, appearance, and refreshment of the desired beverage. The beverage shaker has a tumbler, a top or cap, and a shaving tool incorporated within one of the tumbler or top of the beverage shaker. The shaving tool typically has circumferential ridges, spiral threads, or other protrusions and a pointed end to bruise any fruit added to the beverage being mixed and to create shavings from included flavor ingredients and ice. The shaving tool may be removably disposed in either the tumbler or the top. The shaving tool may have a liquid-filled hollow portion. More than one shaving tool may be commonly connected to the tumbler or top.

### FIELD OF THE INVENTION

The invention pertains to beverage shakers and, more particularly, to an apparatus and method for readily adding fruit or other such ingredients when mixing a beverage.

### BACKGROUND OF THE INVENTION

It is often considered desirable for beverages, cocktails or mixed drinks to be chilled for consumption. Such chilling can be accomplished by several known methods including chilling the drink glass prior to filling, chilling the ingredients of the mixed drink prior to using them, or adding ice to the drink. However, for many cocktails or mixed drinks it is considered undesirable to add ice directly to the drink because the melting ice will gradually dilute the drink, changing the taste significantly during consumption.

A common practice for making mixed drinks involves using a beverage or cocktail shaker for simultaneously mixing and cooling the ingredients. This is accomplished by filling a beverage shaker partially (typically two-thirds to three-quarters of the container) full of ice, adding the ingredients for the cocktail or mixed drink, placing a top on the drink or cocktail shaker, and shaking the contents vigorously for several seconds. After completing these steps, the contents may be poured into a glass or other container by opening the top of the drink or cocktail shaker a sufficient amount to allow the liquid contents to escape while retaining any ice or other solid ingredients in the shaker. The ice may also be retained in the drink or cocktail shaker by a small opening within the drink or cocktail shaker, or the top or cap. Also, ice or other solid ingredients may be removed from the drink using a well-known cocktail strainer. Additionally, the glass may be chilled to assist in keeping the drink cold for a longer time period.

Several attempts to overcome the deficiencies found in beverage mixing apparatus and methods may be found in the prior art. For example U.S. Pat. No. 45,309 for EGG-BEATER, issued Dec. 6, 1864 to Bliss discloses a glass vessel with protuberances or projections formed from the glass vessel, projecting internally.

U.S. Pat. No. 2,021,495 for BEVERAGE MIXER AND COOLER, issued Nov. 19, 1935 to Anderson, discloses a beverage mixer and cooler comprised of an open top container and an open top ice-holding shell that removably fits within the container. The ice container has projecting agitating fins that allow the liquid to flow past the ice in direct contact.

U.S. Pat. No. 3,397,867 for CUPS, MUGS, OR SIMILAR LIQUID CONTAINER, issued Aug. 20, 1968 to Van't Hoff, discloses internal projections of a saw-tooth configuration placed near the bottom of a cup, mug, or similar vessel to facilitate and promote the mixing of material placed in the cup as liquid is added.

U.S. Pat. No. 3,659,825 for DISH FOR MIXING DENTURE REPAIR MATERIALS, issued May 2, 1972 to Reiter, discloses a dish including a heavy walled cylindrical holder and a relatively light walled receptacle removably disposed within said holder.

U.S. Pat. No. 4,003,555 for DRINK SHAKER, issued Jan. 18, 1977 to Swartz, discloses a drink shaker for mixing solids, and particularly those that tend to lump, and liquids, to mix beverages. The shaker comprises first and second containers of tumbler configuration, and a basket member formed to have its side wall and floor of a foraminous character. The basket member is to receive the solids to be mixed into the liquids of the drink and the basket member is formed to rest within the first container on a ledge structure provided for that purpose. The basket member is also formed for friction fit reception and retention within the second container. The second container is formed for a plug fit liquid sealing securement application within the first container. The basket member is shaped to provide for movement of the liquids on shaking into the second container for application to the solids in the basket member from both sides of same. With the liquids to be mixed placed in the first container and the solids to be mixed placed in the basket member that is then rested in the first container, the second container is seated on the first container in liquid sealing relation thereto as well as in friction fit retention relation to the basket member. The basket is so constructed as to facilitate fragmentation and dispersion of the solids into the liquids, during the shaking operation. When the shaking is completed, separation of the containers effects removal of the basket member from the first container as a unit with the second container.

U.S. Pat. No. 4,332,482 for FLUID MIXER, issued Jun. 1, 1982 to Engler, discloses a fluid mixer for insertion into a container having the fluid to be mixed. The fluid mixer generally comprises an insertion member having an open top and bottom and a perimeter substantially similar and equal to that of the interior of the container having the fluid to be mixed. A plurality of mixing blades is carried on the insertion member with each extending inwardly toward the vertical axis of the container to urge the fluid upwardly or downwardly upon reciprocal rotation of the container about its vertical axis.

U.S. Pat. No. 6,409,374 for BEVERAGE TASTING VESSEL WITH AERATING RIDGES AND AGITATING RIBS, issued Jun. 25, 2002 to Willat, discloses a stackable, recyclable, plastic beverage tasting vessel, preferably used for tasting wine. The vessel comprises a bottom portion and a side wall extending upwardly and outwardly from the bottom portion and terminating in an open top having an outwardly extending rim. The rim comprises a curved portion with a plurality of radially extending ridges for aerating the beverage, an angled edge portion for directing the beverage to the top of a taster's tongue, and a curved pouting lip portion for directing the beverage to the sides and under a taster's tongue. The vessel further comprises a raised portion or dome formed in the bottom of the vessel and projecting upwardly into the interior of the vessel, and a platform portion formed on a portion of the raised portion. The vessel further comprises at least one radially projecting rib integral with the interior surface of the side wall and positioned opposite the platform portion. The platform portion and the rib are designed to maximize the mixing of the beverage inside the vessel. The vessel may also comprise a magnifier panel, textured panel, lid, and other features.

U.S. Published Patent Application No. 2012/0031137 for FROZEN BEVERAGE DEVICE, published Feb. 9, 2012 upon application by Bucceri, discloses a frozen beverage device with a container and sealable cover to convert a liquid, such as a non-alcoholic or alcoholic beverage into an at least semi-frozen slurry containing ice crystals. Freezing devices, which may have a range of shapes, contain refrigerant to form a thin layer of ice/ice crystals on the deformable walls of the freezing devices, the ice crystals being released therefrom due to agitation of the liquid by shaking/rotation and/or squeezing on the container and/or cover.

None of the patents or published patent application, taken singly, or in any combination are seen to teach or suggest the novel cocktail shaker of the present invention.

### SUMMARY OF THE INVENTION

In accordance with the present invention, there is provided a novel apparatus and method of mixing the ingredients for a beverage, including a cocktail or mixed drink.

It is considered desirable for numerous beverages, cocktails or mixed drinks to be chilled for consumption. Such chilling can be accomplished by several known methods. These methods include: pre-chilling the drink glass, chilling the ingredients of the mixed drink prior to using them, or adding ice to the drink. However, for many beverages, cocktails or mixed drinks it is considered undesirable to add ice directly to the drink because the melting ice may gradually dilute the drink, and possibly change the taste of the drink significantly during its consumption. It may, however, be desirable for a small amount of fine ice to be suspended in a cocktail or mixed drink when it is presented for consumption.

The disclosed novel apparatus allows easily adding fruit or other solid or semi-solid ingredients to a mixed drink. A novel skiving apparatus allows fruit or other such ingredients to be shaved, bruised, pulped, or otherwise processed during the shaking of the beverage, cocktail, or mixed drink. In addition to acting on the added fruit or other ingredients, the skiving apparatus helps to shave any ice in the beverage shaker. The novel skiving apparatus contributes to rapid drink mixing.

The novel skiving apparatus is typically formed by one or more internal projections each having a number of circular or spiral ribs, threads, or the like. These projections simultaneously bruise or shave fruit or other solid or semi-solid ingredients. The skiving apparatus simultaneously shaves ice as the contents are sealed within the shaker and agitated (e.g. shaken). The novel apparatus improves the resulting mixed drink by quickly extracting flavor components such as fruit pulp. Adding fruit or other such ingredients in larger pieces minimizes the amount of prep time of such ingredients prior to mixing a cocktail or mixed drink. Ice may be added to the beverage shaker in larger sized pieces than is normally done as the ice is also skived into smaller pieces by the agitation of the novel beverage shaker.

It is, therefore, an object of the invention to provide a shaving or skiving device incorporated within a cocktail or beverage shaker.

It is another object of the invention to provide a cocktail or beverage shaker that incorporates ice shavings in the resulting beverage, cocktail, or mixed drink.

It is a further object on the invention to provide a method for enhancing the flavor and appearance of a beverage, cocktail, or mixed drink.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a front perspective view of a beverage shaker of prior art of a type known as a “Boston” shaker.

FIG. 2 is a front perspective, schematic view of another beverage shaker of the prior art cocktail shaker having a tumbler and a mating top.

FIG. 3 is a front perspective, schematic view of another beverage shaker of the prior art cocktail shaker having a tumbler, a mating top, and a removably disposed cap.

FIG. 4A is a front cross-sectional, schematic view of one embodiment of a novel beverage shaker incorporating a shaving or skiving apparatus in a top thereof in accordance with the invention.

FIG. 4B is a front cross-sectional, schematic view of another embodiment of a novel beverage shaker incorporating a shaving or skiving apparatus in a tumbler thereof in accordance with the invention.

FIG. 5 is a front perspective, schematic view of yet another embodiment of a novel beverage shaker incorporating a shaving or skiving apparatus in a top thereof in accordance with the invention.

FIG. 6 is a front cross-sectional, schematic view of the beverage shaker of FIG. 5.

FIG. 7 is a front cross-sectional, schematic view of an alternate embodiment of the novel beverage shaker in accordance with the invention having a skiving apparatus projecting from the bottom of the beverage shaker tumbler.

FIG. 8 is a front perspective schematic view of one embodiment of a novel beverage shaker incorporating a shaving or skiving apparatus in a top, the top being open at the uppermost end thereof, additionally incorporating a cap in accordance with the invention.

FIG. 9 is a front cross-sectional, schematic view of the beverage shaker of FIG. 8.

FIG. 10 is a front cross-sectional, schematic view of an alternate embodiment of the novel beverage shaker of FIG. 8 in accordance with the invention having a skiving apparatus projecting from the bottom of the beverage shaker tumbler.

FIG. 11A through 11C are front perspective schematic views of three alternatives of the skiving apparatus.

FIGS. 12A through 12C are front perspective, schematic views of three additional alternate embodiments of the skiving apparatus of the invention.

FIG. 13 is a front perspective, schematic view of an alternate embodiment of the skiving apparatus of the invention having threads for attachment to the straining plate of FIG. 9.

FIG. 14 is a front perspective, schematic view of an alternate embodiment of the skiving apparatus incorporating a hollow center to hold liquid and having threads for attachment to the straining plate of FIG. 9.

FIG. 15 is a front perspective, schematic view of an alternate embodiment of the skiving apparatus incorporating multiple skiving tools attached to a common support.

FIG. 16 is a front perspective, schematic view of an alternate embodiment of the skiving apparatus having corrugated protrusions and threads for attachment to the straining plate of FIG. 9.

### DETAILED DESCRIPTION OF THE PREFERRED EMBODIMENT

The advantages of adding a skiving apparatus to a beverage shaker have been discussed hereinabove. The apparatus in accordance with the invention adds a unique shaving or skiving tool to the interior of a cocktail mixer of the prior art. The skiving tool bruises any fruit added to the beverage being mixed, shaves ice in the shaker, and further shaves other flavoring elements added to the drink being mixed.

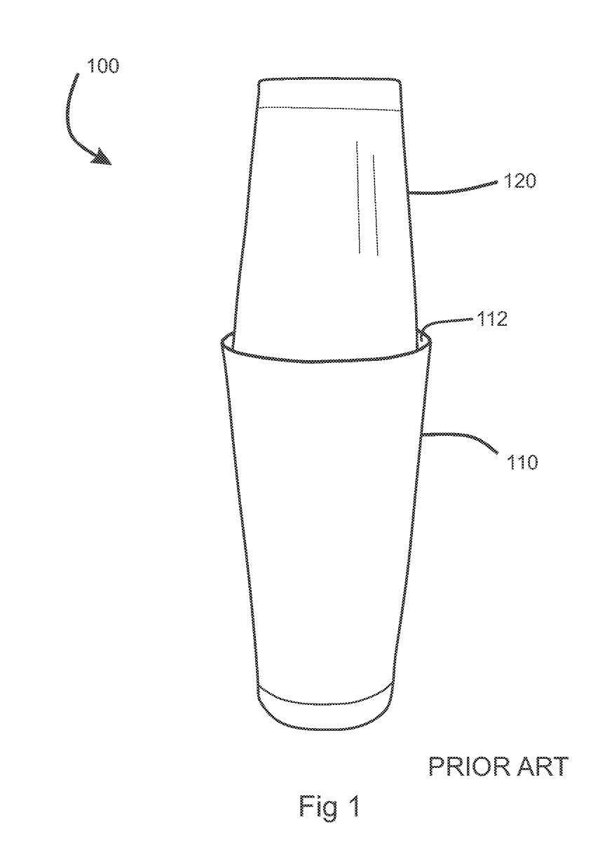

Referring first to FIG. 1, there is shown a front perspective schematic view of a prior art beverage shaker known to those of skill in the art as a Boston shaker, generally at reference number 100. Shaker 100 consists of a tumbler 110 and an inverted top 120. The inverted top 120 may be situated with the tumbler 110 such that the rim, not specifically identified, of the inverted top creates a temporary seal against the top interior surface 112, of the tumbler 110. The tumbler is typically formed from a metal, such as stainless steel or aluminum, but may also be formed from plastic, glass, or other suitable materials. Typically inverted top 120 is a glass or similar tumbler. However, inverted top 120 may be any closed vessel that can form a temporary seal against the tumbler 110. The inverted top 120 may be formed from a metal, such as stainless steel or aluminum as well as from plastic, glass, or other suitable materials.

In use, the ingredients for a beverage or cocktail are added to the tumbler 110. The ingredients placed in the tumbler 110 depend on the beverage or cocktail desired, but they may include some type of fruit, extract, or other flavor enhancing additive, and typically include ice to cool the beverage to a refreshing and appealing temperature.

After the ingredients have been placed in the tumbler 110, the inverted top 120 is placed over and into the tumbler 110 to form the Boston shaker 100. The Boston shaker 100 is then shaken for a desired time, usually between five and ten seconds.

Next, the beverage may be poured into another vessel, not shown, by separating the tumbler 110 and the inverted top 120 enough to allow the liquid ingredients to pour from the Boston shaker 100 into another vessel such as a glass, while keeping any ice and larger flavor additives (such as pieces of fruit) in the Boston shaker 100. Alternatively, the top 120 may be removed from the tumbler 110, and the contents may be poured into another vessel, not shown, through a cocktail strainer, believed to be well known to those of skill in the art. Such a cocktail strainer forms no part of the invention.

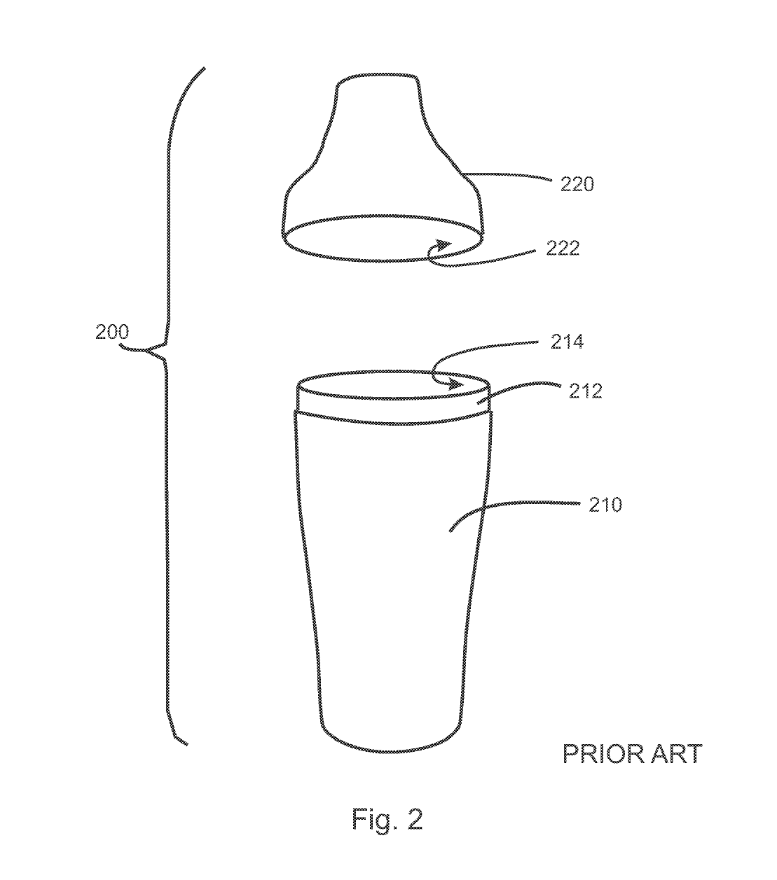

Referring now also to FIG. 2, there is shown a front perspective, schematic view of another prior art beverage shaker generally at reference number 200. Beverage shaker 200 comprises beverage shaker tumbler 210 and beverage shaker top 220 removably attachable thereto. Beverage shaker tumbler 210 has an interior surface 214, and a mating lip 212 of beverage shaker tumbler 210 fashioned to mate snugly with an interior surface 222 of the beverage shaker top 220. The beverage shaker tumbler 210 and beverage shaker top 220 are typically formed from metal, such as stainless steel, aluminum, etc. However it will be recognized that beverage shaker tumbler 210 and shaker top 220 alternately may be formed from plastic or any other suitable materials. The ingredients placed in the tumbler 210 depend on the beverage or cocktail desired, but they may include some type of fruit, extract, or other flavor enhancing additive, and typically include ice to cool the beverage to a refreshing and appealing temperature.

After the ingredients have been placed in the tumbler 210, the beverage shaker top 220 is placed over the tumbler 210 and forms a seal between the interior surface of the beverage shaker top 220 and the mating lip of the beverage shaker tumbler 212. The beverage shaker 200 is then shaken for a desired time, usually between five and ten seconds.

Next, the beverage is poured into another vessel, not shown, by separating the beverage shaker tumbler 210 and the beverage shaker top 220 enough to allow the liquid ingredients to pour from the Boston shaker into another vessel, or by pouring the contents through a cocktail strainer, as previously described.

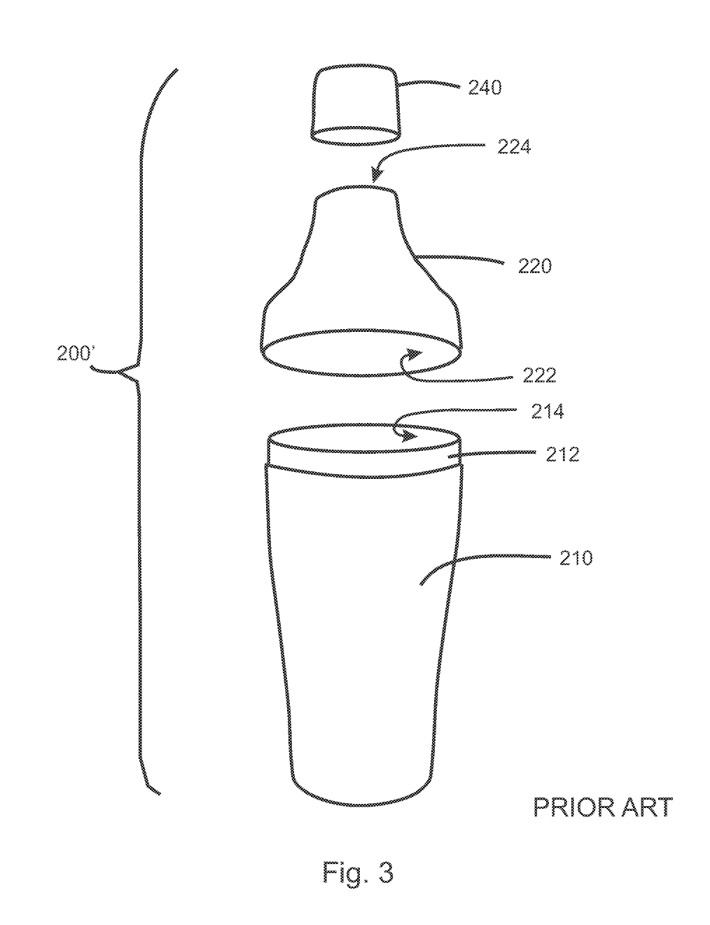

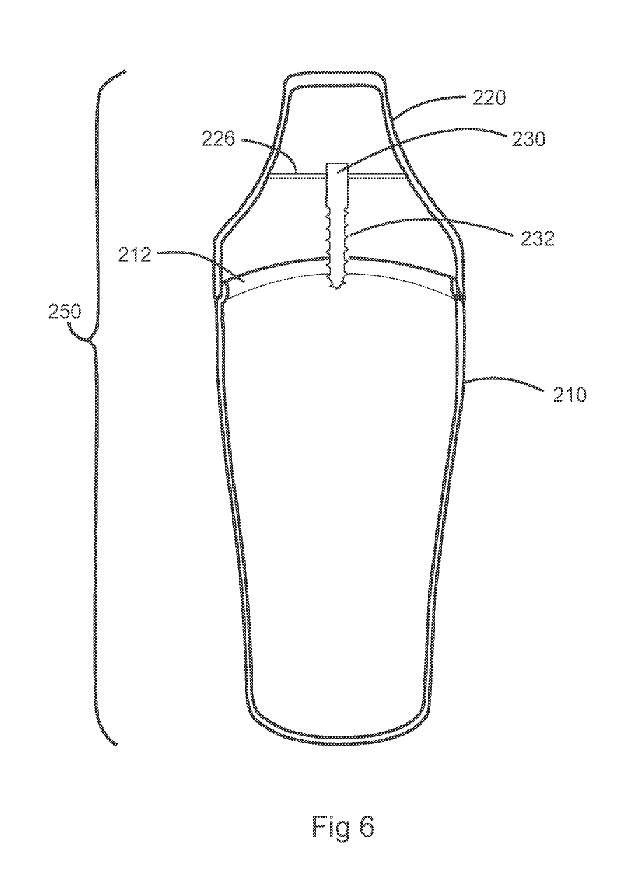

Referring now also to FIG. 3, there is shown a front perspective, schematic view of another prior art beverage shaker generally at reference number 200′. Beverage shaker 200′ is similar to beverage shaker 200 and has a beverage shaker top 220 having an open uppermost end 224 which is provided to allow the contents to be poured into another vessel, not shown. The beverage shaker top 220 generally includes a strainer, shown in FIG. 6 at reference number 226, or other means to constrain ice and larger pieces of fruit or other flavor ingredients within the beverage shaker 200′. A cap 240 forms a seal with the beverage shaker top 224 to enclose the beverage shaker 200′.

The beverage shaker tumbler 210, beverage shaker top 220 and beverage shaker cap 240 are typically formed from metal, such as stainless steel, aluminum, etc. However it will be recognized that beverage shaker tumbler 210, shaker top 220, and shaker cap 240 alternately may be formed from plastic or any other suitable materials.

In use, ingredients for the beverage are added to the beverage shaker tumbler 210, in similar fashion as described for FIG. 2. After the ingredients have been added and the beverage shaker top 220 and cap 240 have been placed over the tumbler, the ingredients are shaken as previously described. Next, the beverage shaker cap 240 is removed, and the ingredients may be poured out though the beverage shaker top 220 while retaining the ice and larger flavor ingredients within the beverage shaker tumbler 210.

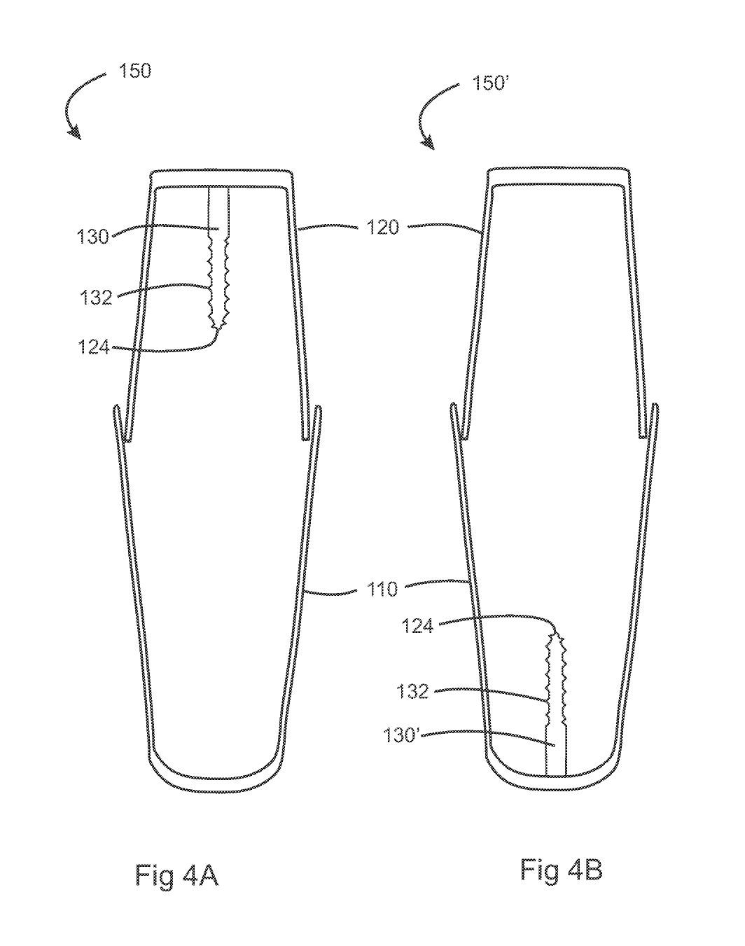

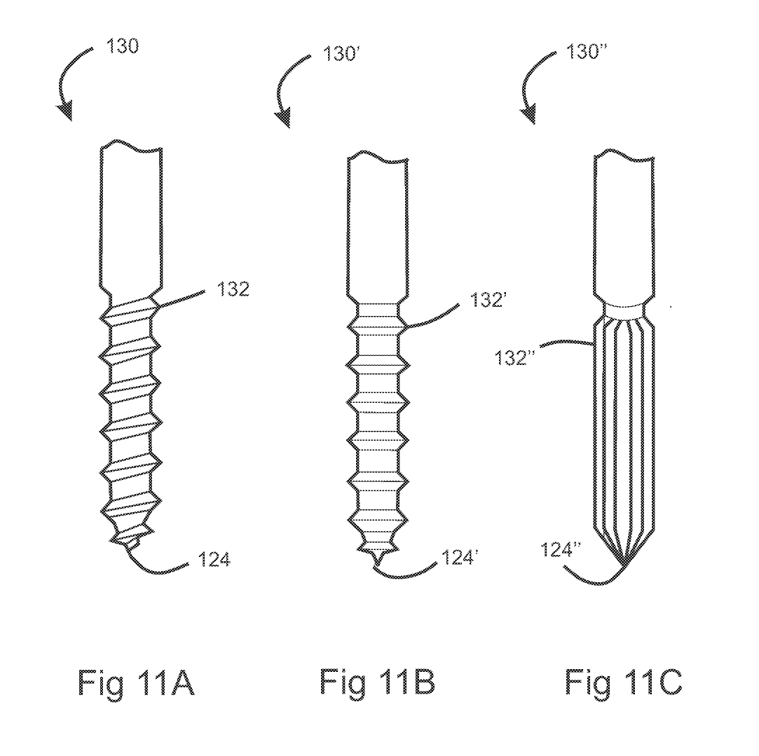

Referring now also to FIGS. 4A and 4B, there are shown front cross-sectional schematic views of novel beverage shakers generally at reference numbers 150 and 150′, respectively, incorporating a centrally located shaving or skiving apparatus 130, 130′ in accordance with the invention. In FIG. 4A, the novel skiving apparatus 130 is attached to an inverted top 120, forming a novel enhanced Boston-style shaker 150. In the illustrated embodiment, the shaving or skiving apparatus 130 is an elongated, cylindrical structure terminating at a point 124. Skiving apparatus 130 has spiral threads 132 disposed circumferentially around its exterior, similar to the threads found on a fastener such as a lag screw or bolt or other similar fastener. A detailed view of skiving apparatus 130 is best seen in FIG. 11A. The shaving or skiving apparatus 130 does not depend on spiral threads to function, and may alternately use individual circumferential protrusions, or axial spines, or any other geometry that produces shavings of ice and ingredients. The skiving apparatus 130 may be threadably engaged with the inverted top 120, or attached by means of adhesive, welding, brazing, forming, or other means known to those skilled in the art. In FIG. 4B, the novel skiving apparatus 130 as described above is attached to the bottom of the beverage shaker tumbler 110, to form an alternate novel enhanced Boston-style shaker 150′.

In use, beverage ingredients are placed in the beverage shaker tumbler 110, the inverted top 120 is placed over and into the tumbler 110 to form a novel enhanced Boston-style shaker 150 (or 150′).

The skiving apparatus 130, 130′ serves to bruise and shave flavor ingredients (e.g. fruit) previously added to the beverage shaker tumbler 110, and serves to create ice shavings from ice cubes added to the beverage shaker tumbler 110 to cool the beverage, producing the advantageous result that shavings of flavor ingredients and ice are provided with the beverage, enhancing the flavor and refreshing temperature of the beverage, without diluting the beverage while it is consumed. Additionally, the ice and ingredient shavings provide a desirable appearance to the beverage.

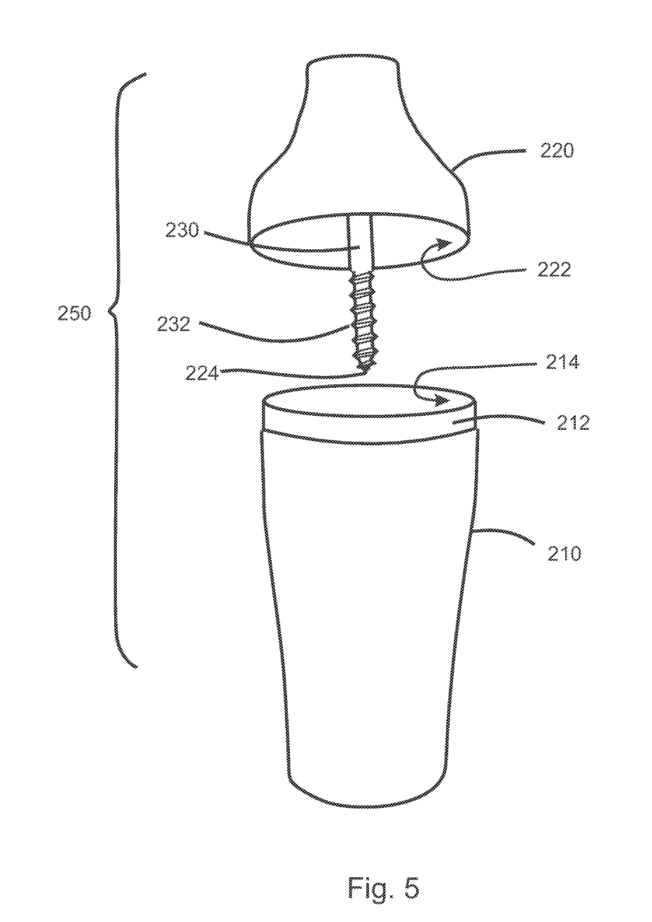

Referring now to FIG. 5, there is shown a front perspective, schematic view of yet another embodiment of a novel beverage shaker generally at reference number 250 in accordance with the invention. A beverage shaker tumbler 210 has an interior surface 214 and a mating lip 212 designed to engage a beverage shaker top 220, producing a seal between the beverage shaker tumbler 210 and the beverage shaker top 220. While this embodiment illustrates a slip or friction fit between the mating lip 212 of the beverage shaker tumbler 210 and the interior surface of the beverage shaker top 222, it will be recognized by those skilled in the art that other methods may be used to engage the beverage shaker tumbler 210 and the beverage shaker top 220, such as cooperating threads, elastomeric seals, and the like. Additionally, elastomeric seals may be used to replace or augment the seal between beverage shaker tumbler 210 and beverage shaker top 220.

The novel beverage shaker top 220 having interior surface 222 incorporates a centrally located shaving or skiving apparatus 230. The shaving or skiving apparatus 230 may or may not be removably disposed within the beverage shaker top 220. In the illustrated embodiment, the shaving or skiving apparatus 230 is an elongated, cylindrical structure terminating at a point 224. Skiving apparatus 330 has spiral threads 232 disposed circumferentially around its exterior, similar to the threads found on a fastener such as a lag screw or bolt or other similar fastener. The shaving or skiving apparatus 230 does not depend on spiral threads to function, and may instead use individual circumferential protrusions, or axial spines, or any other geometry that produces shavings of ice and ingredients.

In use, beverage ingredients are placed in the beverage shaker tumbler 210, and the beverage shaker top 220 is placed over the mating lip of the beverage shaker tumbler 212. The skiving apparatus 230 serves to bruise, pulp and/or shave flavor ingredients (e.g. fruit) previously added to the beverage shaker tumbler 210, and serves to create ice shavings from ice cubes added to the beverage shaker tumbler 210 to cool the beverage, producing the advantageous result that shavings of flavor ingredients and ice are provided with the beverage, enhancing the flavor and refreshing temperature of the beverage, without diluting the beverage while it is consumed.

Referring now also to FIG. 6, there is illustrated a front cross-sectional schematic view of the beverage shaker 250 of FIG. 5. In this embodiment, the skiving apparatus 230 is attached to a straining plate 226 which is attached to the interior of the beverage shaker top 220. The skiving apparatus 230 may be attached to the beverage shaker cap 220 in many other ways, such as threadably attaching to the straining plate 226, or securing in place by gluing, pressing, welding, brazing, or other methods known to those of skill in the art. Additionally, the shaving or skiving apparatus 230 may be molded or formed in one piece with the beverage shaker top 220.

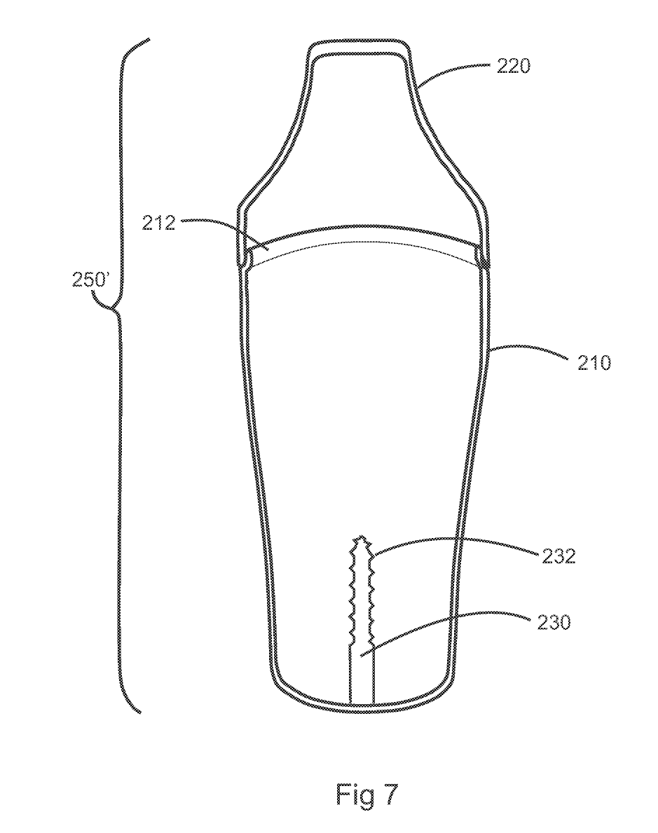

Referring now also to FIG. 7, there is illustrated a cross-sectional schematic view of an alternate embodiment of the novel beverage shaker 250′. In this embodiment, the skiving apparatus 230 is attached to the interior of the beverage shaker tumbler 210. The skiving apparatus 230 may be attached to the beverage shaker tumbler 210 by threaded fittings, or secured in place by gluing, pressing, welding, brazing, or other methods known to those of skill in the art. Additionally, the shaving or skiving apparatus 230 may be molded or formed in one piece with the beverage shaker tumbler 210.

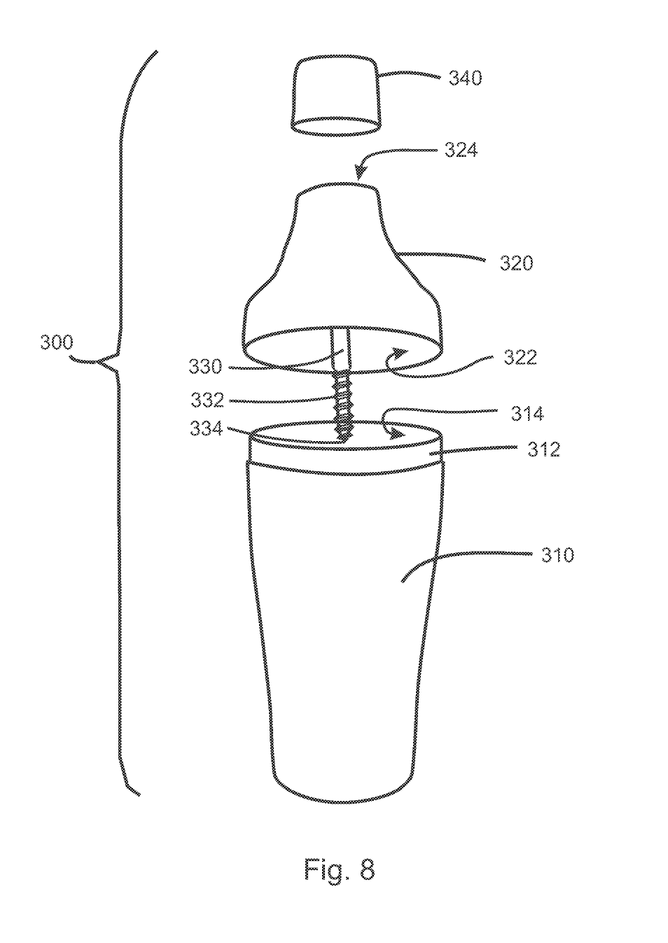

Referring now also to FIG. 8, there is illustrated a front perspective, schematic view of another embodiment of a novel beverage shaker generally at reference number 300 incorporating a beverage shaker tumbler 310, a shaving or skiving apparatus 330 in a beverage shaker top 320, the top 320 being open at the uppermost end 324 thereof, and additionally incorporating a cap 340 in accordance with the invention. In this embodiment, shaker top 320 is not sealed at the uppermost surface 324. A separate shaker cap 340 forms a seal with the beverage shaker top 320. The beverage shaker top 320 comprises a shaving or skiving apparatus 330 centrally disposed within the shaker top 320. The shaving or skiving apparatus 330 is an elongated, cylindrical structure terminating at a point 334. Skiving apparatus 330 has spiral threads 332 disposed circumferentially around its exterior, similar to the threads found on a fastener such as a lag screw or bolt or other similar fastener. The shaving or skiving apparatus 330 does not depend on spiral threads to function, and may instead use individual circumferential protrusions, or axial spines, or any other geometry that produces shavings of ice and ingredients.

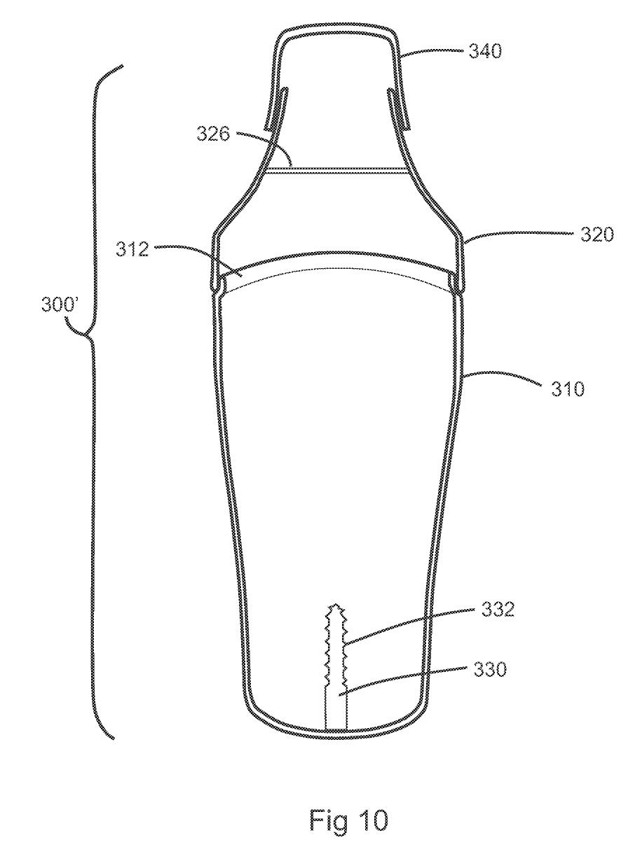

Referring now also to FIG. 9 there is illustrated a front cross-sectional, schematic view of the novel beverage shaker of FIG. 8. In this embodiment, the shaving or skiving apparatus 330 is attached to a straining plate 326 such that the shaving or skiving apparatus is disposed within the interior volume of the beverage shaker tumbler 310 and beverage shaker top 320. Straining plate 326 may be populated with holes or openings that serve as an integrated strainer.

In use, beverage ingredients are placed in the beverage shaker tumbler 310, and the beverage shaker top 320 is placed over the mating lip 312 of the beverage shaker tumbler 310. The shaker cap 340 is placed over the beverage shaker top 320 to form a closed vessel. The novel beverage shaker 300 is then shaken for a desired time, usually between five and ten seconds. The skiving apparatus 330 serves to bruise and shave flavor ingredients (e.g. fruit) previously added to the beverage shaker tumbler 310, and serves to create ice shavings from ice cubes added to the beverage shaker tumbler 310 to cool the beverage, producing the advantageous result that shavings of flavor ingredients and ice are provided with the beverage, enhancing the flavor and refreshing temperature of the beverage, without diluting the beverage while it is consumed. After shaking has been completed, the beverage shaker cap is removed, and the beverage in poured from the beverage shaker 300 into another vessel, not shown, for consumption. Openings provided in the straining plate 326 allow the beverage to flow out of the beverage shaker 300, but retain larger pieces of ice and other flavor ingredients within the beverage shaker 300.

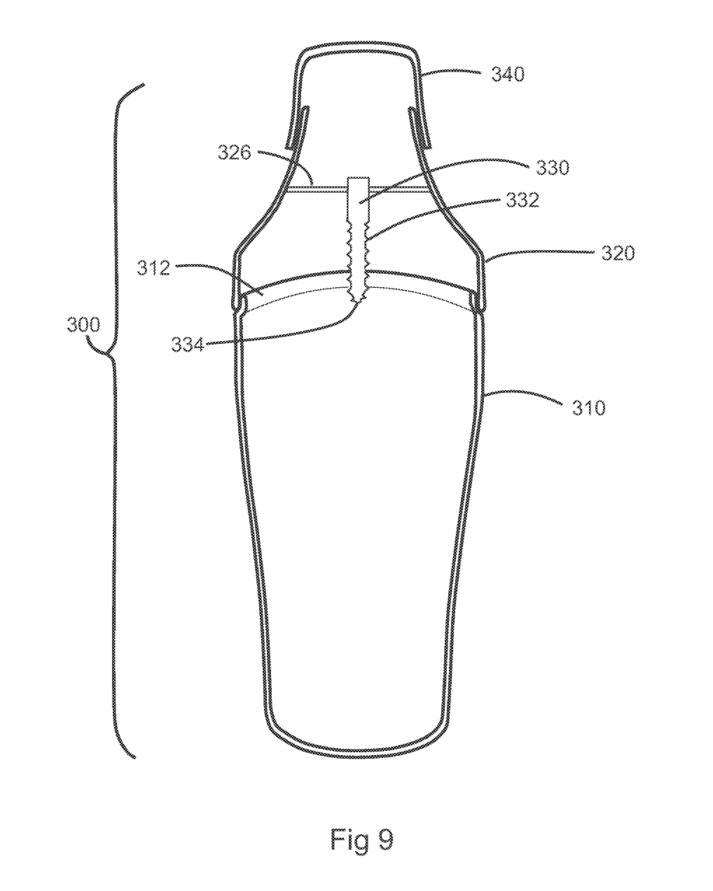

Referring now also to FIG. 10 there is illustrated a front cross-sectional schematic view of an alternate of the novel beverage shaker 300′ of FIG. 8 in accordance with the invention having a skiving apparatus 330 projecting from the bottom of the beverage shaker tumbler 310.

Referring now also to FIGS. 11A through 11C there are illustrated three embodiments of the novel skiving or shaving apparatus generally at reference numbers 130, 130′, and 130″ respectively. In the illustrated embodiments, the shaving or skiving apparatus 130, 130′, and 130″ are elongated, cylindrical structures terminating at a point 124, 124′, and 124″ respectively.

Skiving apparatus 130 has spiral threads 132 disposed circumferentially around its exterior, similar to the threads found on a fastener such as a lag screw or bolt or other similar fastener. The spiral threads 132 serve to skive or shave material from the surface of flavor ingredients and ice that have been added to the beverage shaker, as previously described. The spiral threads 132 and the point 124 also serve to desirably bruise or pulp flavor ingredients.

Skiving apparatus 130′ has circumferentially disposed ribs 132′ around its exterior. The circumferential ribs 132′ serve to skive or shave material from the surface of flavor ingredients and ice that have been added to the beverage shaker in similar fashion to the spiral threads 132 described previously. The circumferential ribs 132′ and the point 124′ also serve to desirably bruise or pulp flavor ingredients.

Skiving apparatus 130″ has longitudinal spines 132″ disposed circumferentially around its exterior. The longitudinal spines 132″ serve to skive or shave material from the surface of flavor ingredients and ice that have been added to the beverage shaker. The longitudinal spines 132″ and the point 124″ also serve to desirably bruise or pulp flavor ingredients.

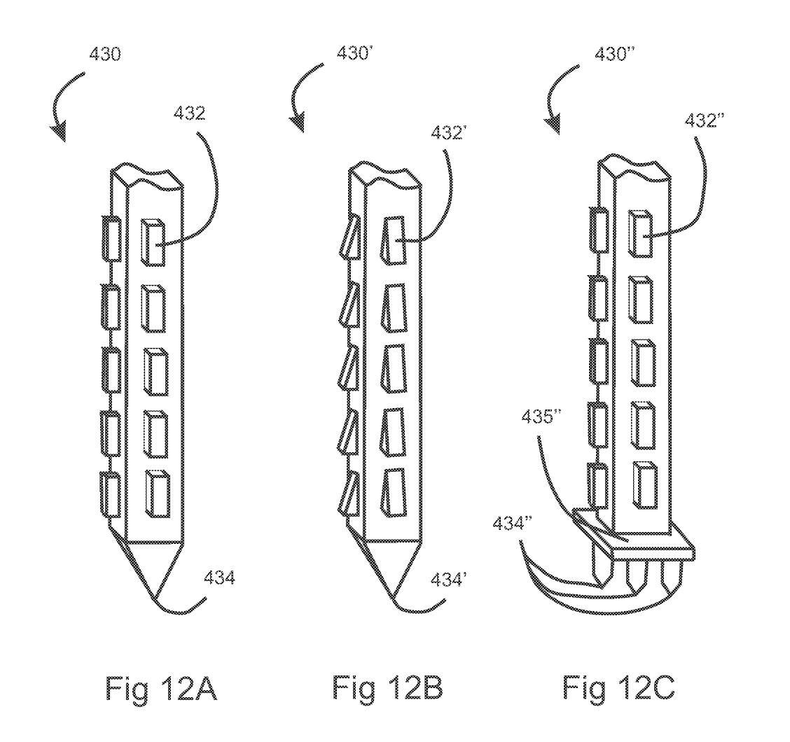

Referring now also to FIGS. 12A through 12C, there are illustrated three embodiments of the novel skiving or shaving apparatus generally at reference numbers 430, 430′, and 430″ respectively. In the illustrated embodiments, the shaving or skiving apparatus 430, 430′, and 430″ are elongated, rectangular structures terminating at a point 434, 434′, and points 434″, respectively.

Skiving apparatus 430 has raised rectangular protrusions 432 disposed around its exterior. The rectangular protrusions 432 serve to skive or shave material from the surface of flavor ingredients and ice that have been added to the beverage shaker, as previously described. The rectangular protrusions 432 and the point 424 also serve to desirably bruise or pulp flavor ingredients.

Skiving apparatus 430′ has angled protrusions 432′ disposed around its exterior. The angled protrusions 432′ serve to skive or shave material from the surface of flavor ingredients and ice that have been added to the beverage shaker in similar fashion to the rectangular protrusions 432 described previously. The angled protrusions 432′ and the point 424′ also serve to desirably bruise or pulp flavor ingredients.

Skiving apparatus 430″ has axial spikes 434″ extending from the base 435″ of the skiving tool 430″. The axial spikes 434″ and the rectangular protrusions 432″ serve to skive or shave material from the surface of flavor ingredients and ice that have been added to the beverage shaker. The axial spikes 434″ and the rectangular protrusions 432″ also serve to desirably bruise or pulp flavor ingredients.

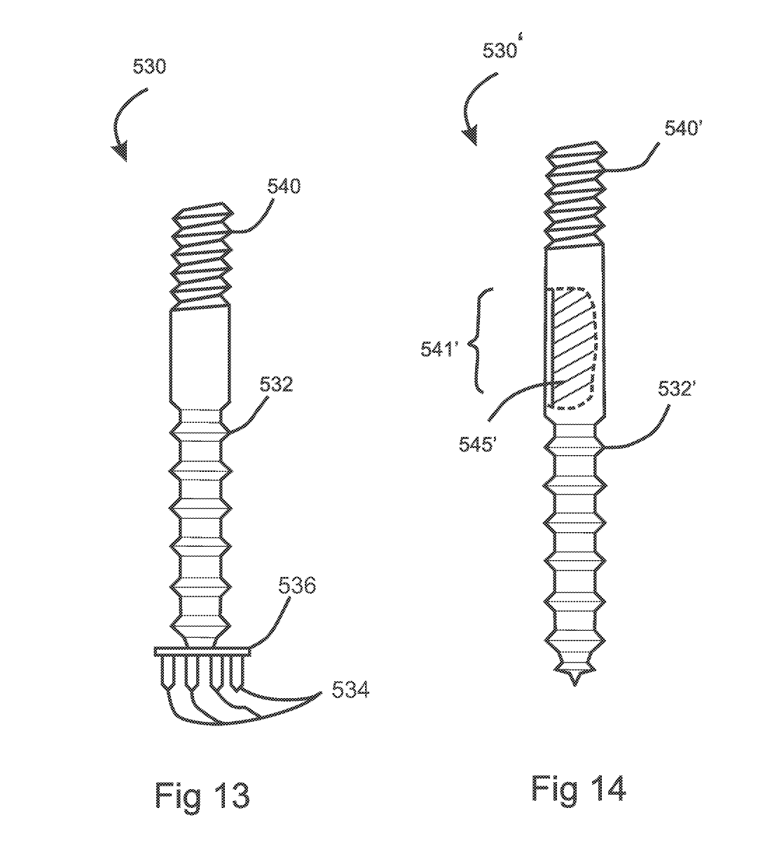

Referring now also to FIG. 13, skiving apparatus 530 has circumferentially disposed ribs 532 around its exterior. Skiving apparatus 530 has axial spikes 534 extending from the base 536 of the skiving tool 530. The axial spikes 534 and the circumferentially disposed ribs 532 serve to skive or shave material from the surface of flavor ingredients and ice that have been added to the beverage shaker. The axial spikes 534 and the circumferentially disposed ribs 532 also serve to desirably bruise or pulp flavor ingredients. Skiving apparatus 530 also illustrates threads 540 for the purpose of removably engaging skiving tool 530 with straining plate 326 (FIG. 9).

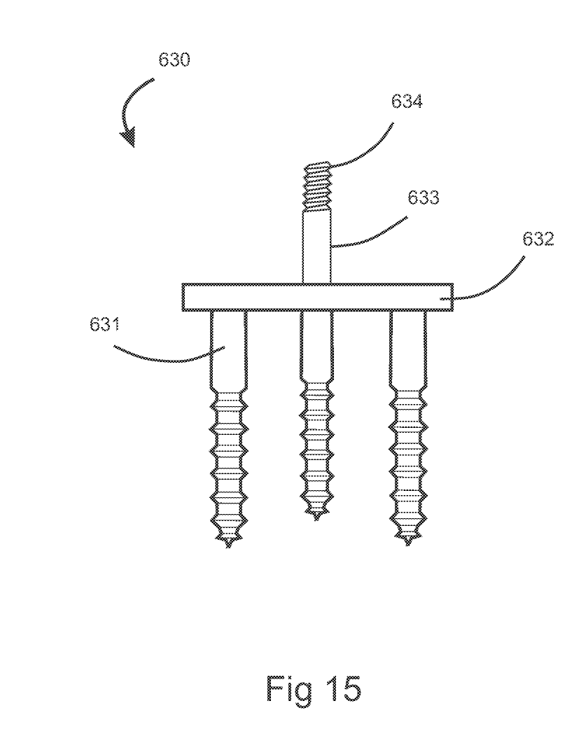

Referring now also to FIG. 14, skiving apparatus 530′ has circumferentially disposed ribs 532′ around its exterior. FIG. 14 further illustrates a cutaway section 541′ showing a hollow section of skiving tool 530′ which is filled with a liquid 545′ to help facilitate cooling of ingredients.

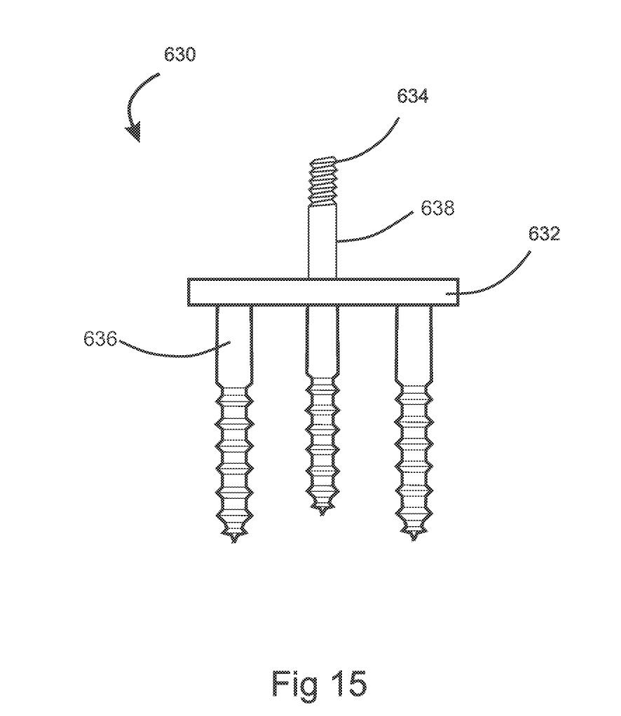

Referring now also to FIG. 15, there is illustrated an embodiment of the novel skiving or shaving apparatus generally at reference number 630. Skiving apparatus 630 has multiple skiving tools 636 radially at equidistant positions from the center of support 632. Skiving apparatus 630 also has an axial support 638 with threaded proximal end 634 to facilitate threaded engagement with said straining plate 326 (FIG. 9).

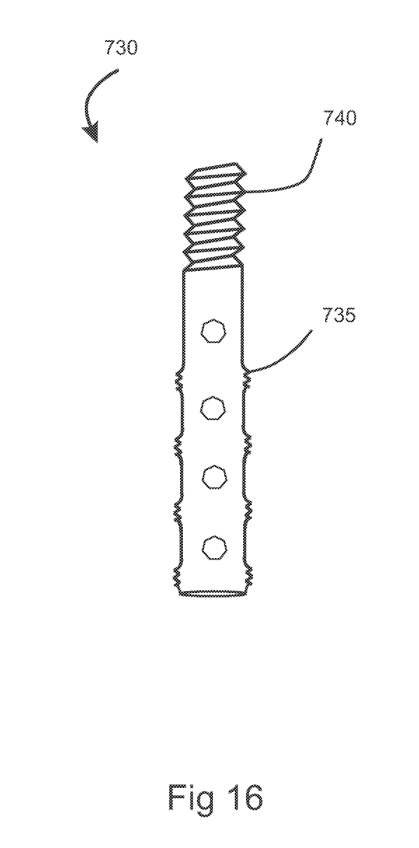

Referring now also to FIG. 16, there is illustrated yet another embodiment of the novel skiving or shaving apparatus generally at reference numbers 730. Skiving apparatus 730 incorporates corrugated protrusions 735 similar to those found on cheese graters. Cheese grater constructions are believed to be well known in the art. Skiving apparatus 730 also illustrates threads 740 for the purpose of removably engaging skiving tool 730 with said straining plate 326 (FIG. 9). The corrugated protrusions 735 serve to skive or shave material from the surface of flavor ingredients and ice that have been added to the beverage shaker, as previously described. The corrugated protrusions 735 also serve to desirably bruise or pulp flavor ingredients.

It will be recognized by those skilled in the art that other variations may be employed to serve the function of shaving or skiving, and for bruising fruit and other flavor ingredients added to the beverage shaker.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A beverage shaker comprising:
a) an elongated tumbler having a substantially circular cross-section, a closed bottom surface, an opposing open top, and a side wall having an interior surface disposed therebetween thereby defining a first cupped container, said first cupped container having a mating lip circumferentially disposed on an outside surface of said side wall adjacent said open top;
b) a top having a substantially circular cross-section, an open bottom, an opposing sealed upper surface and a side wall having an exterior surface disposed therebetween thereby defining a second cupped container, said exterior surface adapted for removable engagement with said mating lip of said first cupped container; and
c) a shaving apparatus retained within at least one of said first cupped container and said second cupped container.

2. The beverage shaker of claim 1 wherein said shaving apparatus comprises an elongated shaft having a cross-sectional shape selected from the group: cylindrical, and rectangular, said shaft having a proximal end, a distal end, a major axis therebetween, said distal end comprising at least one point.

3. The beverage shaker of claim 2 wherein said shaft comprises a cylindrical shaft, said shaft comprising at least one selected from the group: spiral threads and ribs radially protruding from and circumferentially disposed on an exterior surface of said cylindrically shaped shaft along said major axis.

4. The beverage shaker of claim 2 wherein said shaft comprises a rectangular shaft having a plurality of protrusions disposed longitudinally along at least one side of said rectangular shaft between said proximal end and said distal end thereof.

5. The beverage shaker of claim 2 wherein said shaft comprises a hollow portion, said hollow portion being filled with a liquid.

6. The beverage shaker of claim 1 wherein said shaving apparatus comprises at least two independent shaving devices attached at a common attachment point.

7. The beverage shaker of claim 2 wherein said proximal end of said shaving apparatus is attached to the interior of said tumbler proximate a center of said closed bottom surface of said tumbler, and extends outwardly therefrom parallel to a longitudinal axis of said tumbler.

8. The beverage shaker of claim 2 wherein said proximal end of said shaving apparatus is attached to said sealed upper surface of said top proximate a center thereof, and extends outwardly therefrom parallel to a longitudinal axis of said top.

9. The beverage shaker of claim 1, further comprising: mating thread portions disposed on said mating lip of said elongated tumbler and on an interior surface of said top proximate said open bottom, respectively, whereby said elongated top may be sealed to said top.
